(19) United States
(12) Patent Application Publication
(10) Pub. No.: US 2005/0274576 A1
(43) Pub. Date: Dec. 15, 2005

(54) Strand lubrication

(76) Inventor: Timothy L. Coder, Effingham, KS (US)

Correspondence Address: FISH & RICHARDSON PC, P.O. BOX 1022, MINNEAPOLIS, MN, 55440-1022, US

(21) Appl. No.: 11/063,082

(22) Filed: Feb. 22, 2005

Related U.S. Application Data
(63) Continuation-in-part of application No. 10/641,000, filed on Aug. 14, 2003.
Application No. 10/641,000 is a continuation-in-part of application No. 09/991,418, filed on Nov. 15, 2001, now Pat. No. 6,725,973.
(60) Provisional application No. 60/249,413, filed on Nov. 16, 2000.

(51) Int. Cl. F16N 7/16

(52) U.S. Cl. 184/15.2

(57) ABSTRACT

A device dispenses lubricant onto a cable as the cable enters a conduit through which the cable is being pulled. An inside wall flares out in a bell-shaped surface to an entry end of the device where the cable enters, the space enclosed by the inside wall being unobstructed. A lubricant dispensing structure dispenses the lubricant automatically at the inside wall and onto the length of cable. An inside wall defines an inside space through which the cable passes from an entry end of the device to an exit end of the device as the cable is being pulled through the conduit. There is an unthreaded outer cylindrical wall at the exit end of the device, the outer wall having a section of smaller diameter at the exit end and a section of larger diameter spaced apart from the exit end, the smaller diameter and the larger diameter sections corresponding to two different inner diameters of two different conduits, the two different conduits sharing a common outer diameter.

This application is a continuation-in-part of and claims the benefit of priority from U.S. application Ser. No. 10,641,000, filed Aug. 14, 2003 which is a continuation-in-part of application Ser. No. 09/991,418, filed Nov. 15, 2001, which claims priority from provisional application Ser. No. 60/249,413, filed Nov. 16, 2000. The disclosures of the prior applications are considered part of and are incorporated by reference in the disclosure of this application.

This description relates to strand lubrication.

To make it easier to pull a strand or multiple strands (e.g., an insulated electrical wire) through a conduit, the strand is often lubricated. One person typically applies the lubricant, for example, soap, to the strand by hand as one or more other people (depending on the diameter and weight of the strand) withdraw the strand from a coil or other supply and feed it into the conduit. One or more people at the other end of the conduit pull on the strand while it is being lubricated and fed.

The end of the conduit typically has an external thread. After the wire is pulled through the conduit, a standard cylindrical bushing is screwed onto the end of the conduit to protect the wire from damage that might otherwise be caused by the sometimes-rough edge at the end of the conduit.

Various devices have been proposed to simplify the process of lubricating the strand while it is being pulled.

In general, in one aspect, the invention features a device to dispense lubricant onto a cable as the cable enters a conduit through which the cable is being pulled, the device comprising an inside wall that flares out in a bell-shaped surface to an entry end of the device where the cable enters, the space enclosed by the inside wall being unobstructed, and a lubricant dispensing structure to dispense the lubricant automatically at the inside wall and onto the length of cable as the cable is being pulled.

Implementations of the invention may include one or more of the following features. The inside wall includes an annular surface, and the bell-shaped surface has a narrower end that joins the annular surface and a broader end at the entry end of the device. The bell-shaped surface has a circular cross-section and the annular surface has a circular cross-section. The broader end of the bell-shaped surface is at least half again wider than the space surrounded by the annular surface of the inside wall. The region surrounded by the broader end is approximately twice as wide as the space surrounded by the annular surface. The bell-shaped surface and the annular surface are coaxially aligned. The bell-shaped surface comprises a quarter-toroid. The lubricant dispensing structure includes lubricant apertures that open on the inside wall. The inside wall is formed by two portions that can be split apart and rejoined to position the inside wall around the cable in preparation for dispensing lubricant. The lubricant dispensing structure is also formed in two portions that can be split apart and rejoined to form an annular lubricant chamber. The device includes an unthreaded outer cylindrical wall at the exit end of the device, the outer wall having a section of smaller diameter at the exit end and a section of larger diameter spaced apart from the exit end, the smaller diameter and the larger diameter sections corresponding to two different inner diameters of two different conduits, the two different conduits sharing a common outer diameter.

In general, in another aspect, the invention features a device to dispense lubricant onto a cable as the cable enters a conduit through which the cable is being pulled, the device comprising an inside wall that includes an annular surface and flares out in a bell-shaped surface to an entry end of the device where the cable enters, the space enclosed by the inside wall being unobstructed, the bell-shaped surface having a narrower end that joins the annular surface and a broader end at the entry end of the device, the bell-shaped surface and the annular surface having circular cross-sections and being coaxially aligned, the bell-shaped surface being a quarter-toroid, the region enclosed by the broader end of the bell-shaped surface being approximately twice as wide as the space surrounded by the annular surface of the inside wall, a lubricant dispensing structure including apertures that open on the inside wall to dispense the lubricant automatically at the inside wall and onto the length of cable as the cable is being pulled, the inside wall being formed by two portions that can be split apart and rejoined to position the inside wall around the cable in preparation for dispensing lubricant, the lubricant dispensing structure also being formed in two portions that can be split apart and rejoined to form an annular lubricant chamber, and an unthreaded outer cylindrical wall at the exit end of the device, the outer wall having a section of smaller diameter at the exit end and a section of larger diameter spaced apart from the exit end, the smaller diameter and the larger diameter sections corresponding to two different inner diameters of two different conduits, the two different conduits sharing a common outer diameter.

In general, in another aspect, the invention features a device to dispense lubricant onto a cable as the cable enters a conduit through which the cable is being pulled, the device comprising an inside wall defining an inside space through which the cable passes from an entry end of the device to an exit end of the device as the cable is being pulled through the conduit, a lubricant dispensing structure to dispense the lubricant automatically at the inside wall and onto the length of cable while the cable is being pulled, and an unthreaded outer cylindrical wall at the exit end of the device, the outer wall having a section of smaller diameter at the exit end and a section of larger diameter spaced apart from the exit end, the smaller diameter and the larger diameter sections corresponding to two different inner diameters of two different conduits, the two different conduits sharing a common outer diameter.

Implementations of the invention may include one or more of the following features. The transition between the smaller diameter section and larger diameter section is abrupt. The section of smaller diameter extends from the exit end at least 40% of the distance to the entry end of the device. The length of the smaller diameter section is at least twice the length of the larger diameter section. The inside wall includes an annular surface and a bell-shaped surface has a narrower end that joins the annular surface and a broader end at the entry end of the device. The bell-shaped surface has a circular cross-section and the annular surface has a circular cross-section. The broader end of the bell-shaped surface is at least half again wider than the space surrounded by the annular surface of the inside wall. The region surrounded by the broader end is approximately twice as wide as the space surrounded by the annular surface. The lubricant dispensing structure includes lubricant apertures that open on the inside wall. The inside wall is formed by two portions that can be split apart and rejoined to position the inside wall around the cable in preparation for dispensing lubricant.

In general, in another aspect, an apparatus includes (a) a vessel to hold a supply of lubricant to be pumped to a lubricator for application to a cable that is being pulled, (b) a generally vertical guiding column, and (c) a follower plate to ride on an upper surface of the lubricant as the supply of lubricant in the vessel is depleted, the follower plate having a pair of resilient barriers that support the plate on the guiding column, constrain the lubricant within the vessel below the plate, and are spaced apart along the length of the guiding column.

In some implementations, the barriers comprise o-rings, and the guiding column comprises a tube through which the lubricant is pumped.

In general, in another aspect, an apparatus includes (a) a gear pump to pump lubricant to a lubricator for application to a cable that is being pulled, the gear pump having an inlet and an outlet, and (b) an auger to feeds lubricant from a supply in a vessel to the inlet of the pump, (c) the gear pump comprising a pair of meshing gears that force lubricant from a reservoir at a rate based on a gear ratio of the gears, (d) the auger comprising a rotary screw that feeds lubricant at a rate based on a pitch and diameter of the screw, and (e) the pitch and diameter of the screw and the gear ratio of the gears being selected so that the rate at which the auger feeds lubricant is matched to the rate at which the gear pump pumps lubricant.

Among the advantages of the invention are one or more of the following. The lubricator can be used in downward or sideways cable pulling without the need for a brush or other guard to prevent lubricant from dripping from the lubricator. The bell shaped inner surface enables the cable to be fed into the lubricator and the conduit from a direction that is considerably off the axis of the lubricator without damage to the cable. Providing two different diameter sections of the outer wall of the exit end of the lubricator permits the lubricator to be mounted on two different grades of conduit that have the same outer diameter and different inner diameters. Liquid soap or other lubricants (even very viscous lubricants) can be automatically and evenly applied over the wire without the lubricant having to be applied from an electrician's hands. The use of such device by electrical, data, communications, and maintenance personnel who pull wire through conduits will permit a smoother pulling of the wire and less chance of damaging the wire. The use of the mechanical device also reduces manpower requirements and thus labor costs by reducing cleanup time, material costs, and risk of damaging the wire.

Other advantages and features will become apparent from the following description and from the claims.

### DESCRIPTION

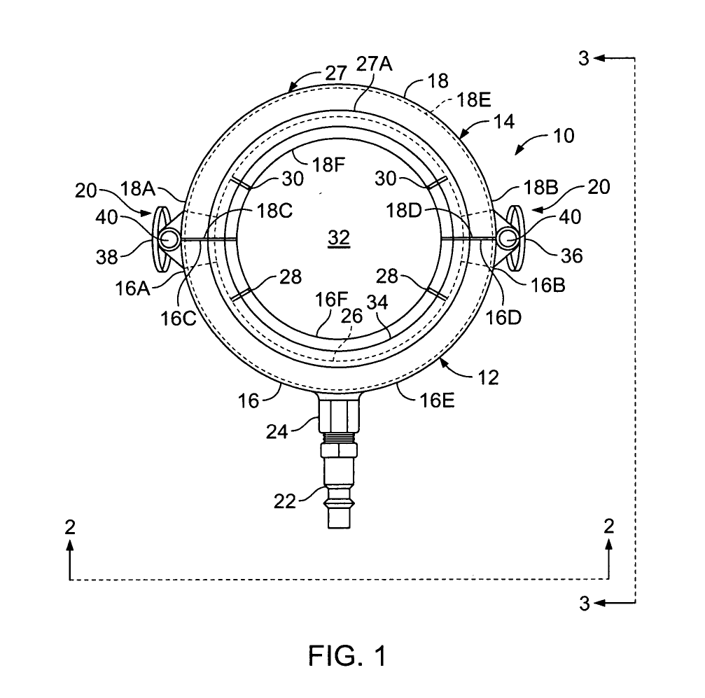

FIG. 1 is a top plan view of an automatic wire-lubricating device shown in an assembled condition.

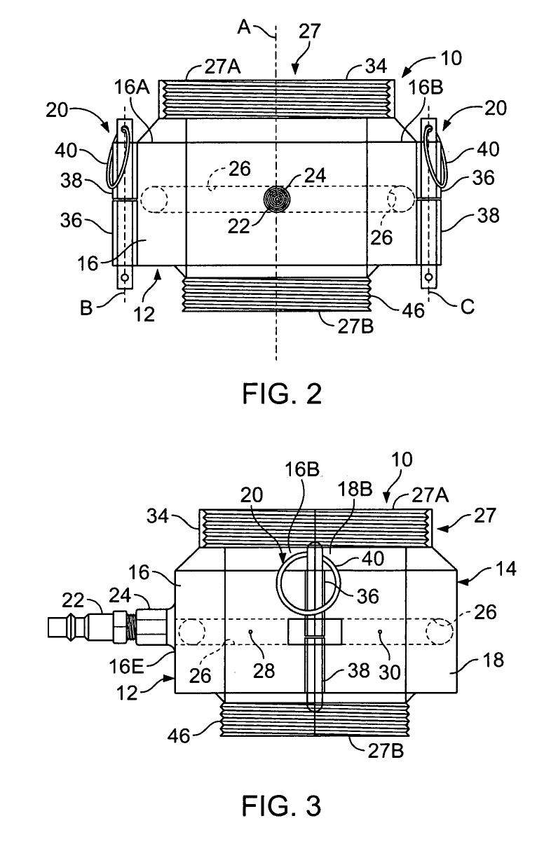

FIG. 2 is a side elevational view of the device as seen along line 2-2 of FIG. 1.

FIG. 3 is another side elevational view of the device as seen along line 3-3 of FIG. 1.

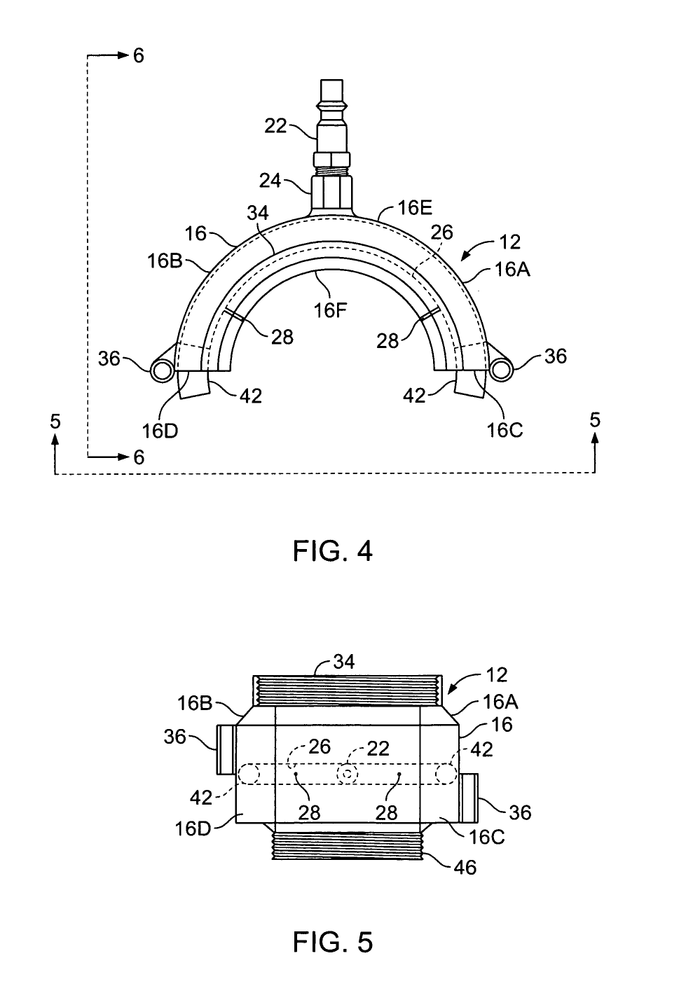

FIG. 4 is a top plan view of a first component of the device representing approximately one half of the device.

FIG. 5 is a side elevational view of the first component of the device as seen along line 5-5 of FIG. 4.

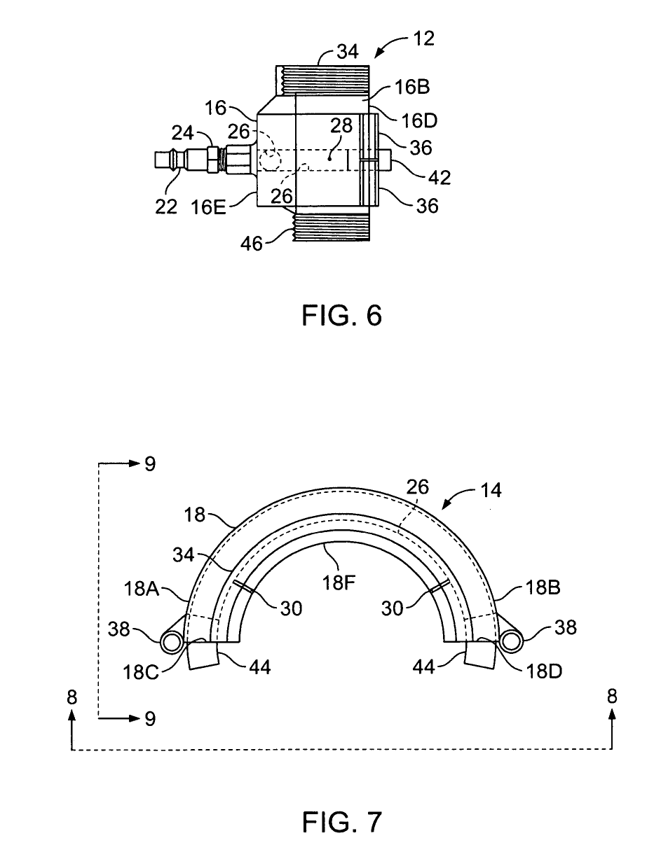

FIG. 6 is another side elevational view of the first component of the device as seen along line 5-5 of FIG. 4.

FIG. 7 is a top plan view of a second component of the device representing approximately the other half of the device.

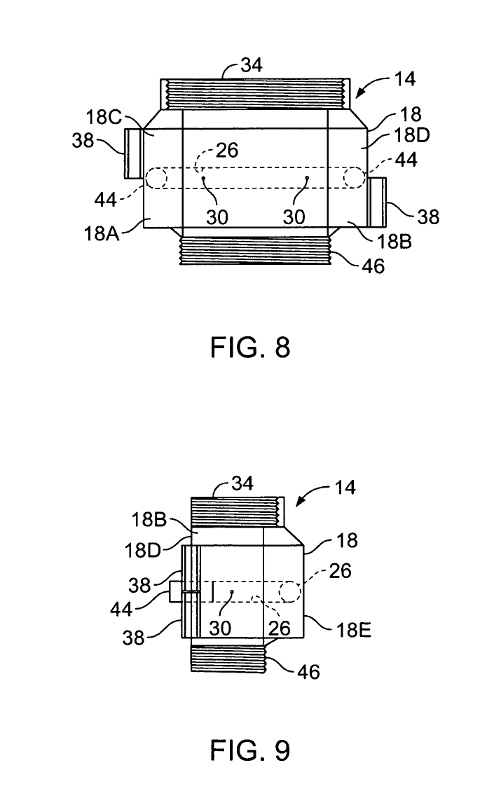

FIG. 8 is a side elevational view of the second component of the device as seen along line 8-8 of FIG. 7.

FIG. 9 is another side elevational view of the second component of the device as seen along line 9-9 of FIG. 7.

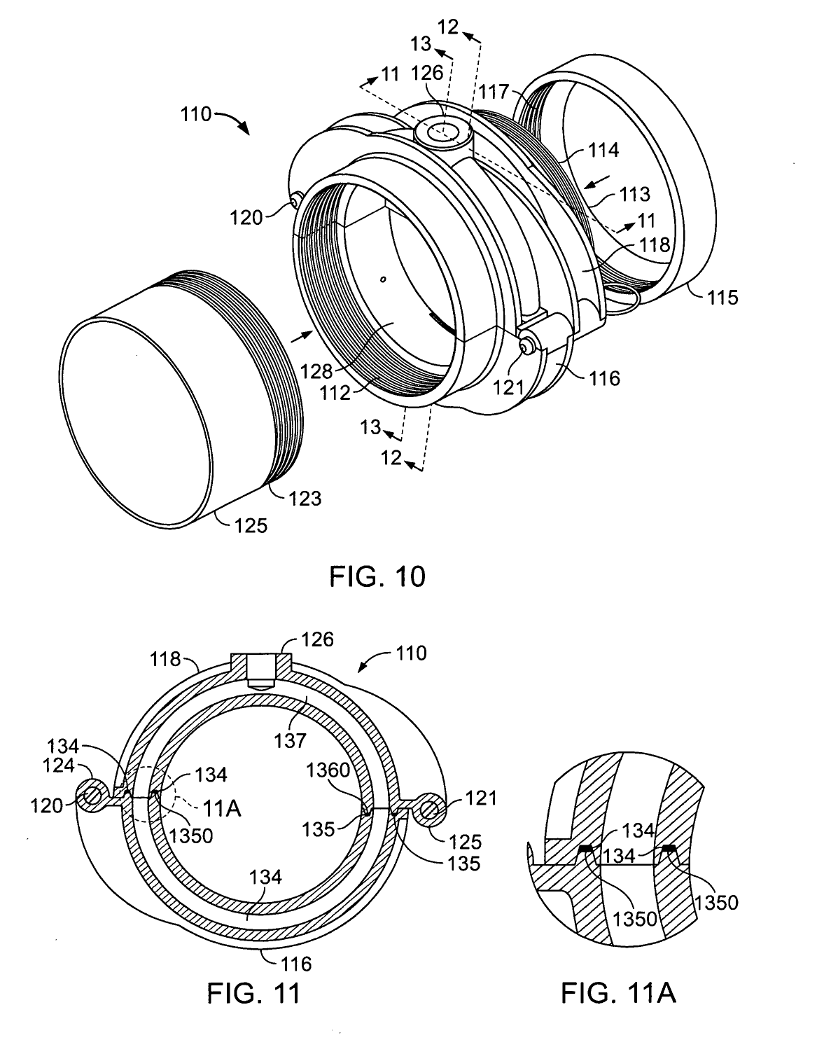

FIG. 10 is a three-dimensional view of another lubricator.

FIG. 11 is a cross-sectional view of the lubricator along line 11-11 of FIG. 10.

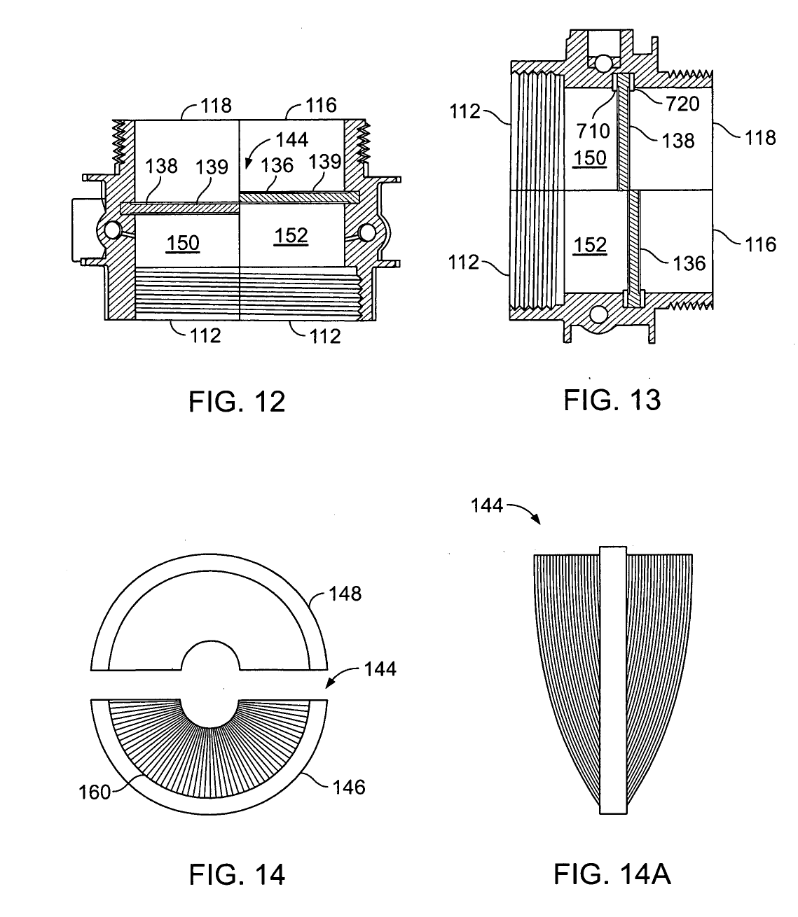

FIGS. 12 and 13 are side-sectional views of the lubricator along lines 12-12 and 13-13 of FIG. 10.

FIG. 14 is a top view of a dismantled brush.

FIG. 14A is a side view of the brush.

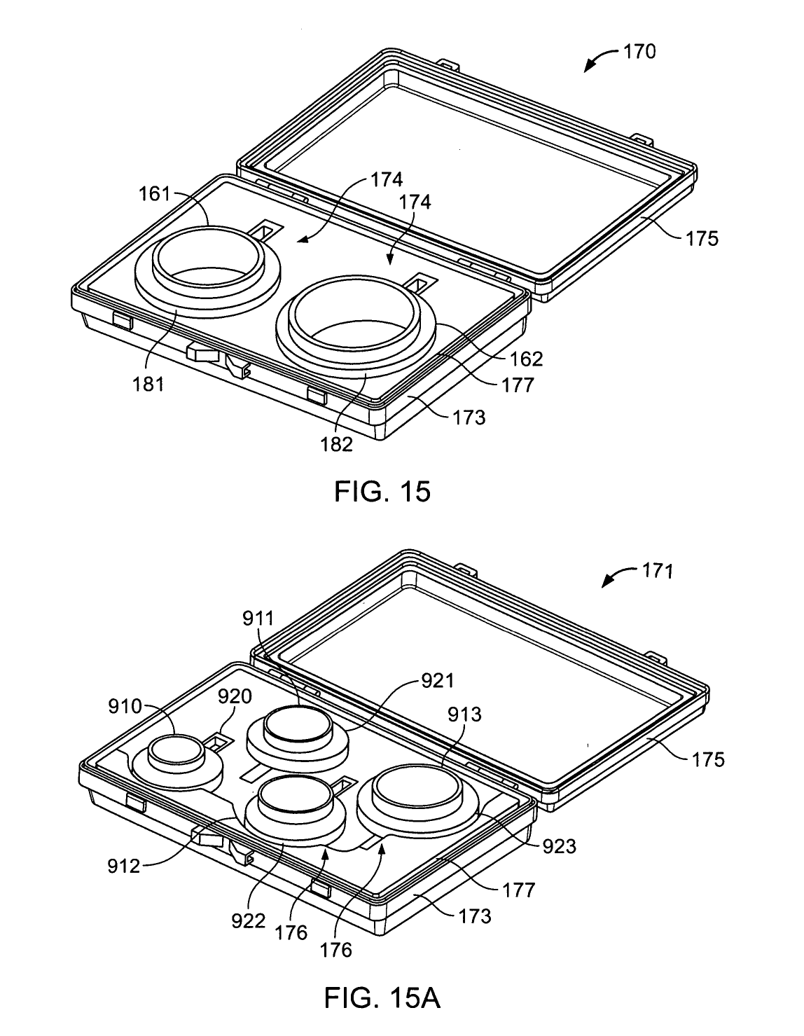

FIG. 15 is a three-dimensional view of a holder for the largest diameter lubricators.

FIG. 15A is a three-dimensional view of a holder for the medium diameter lubricators.

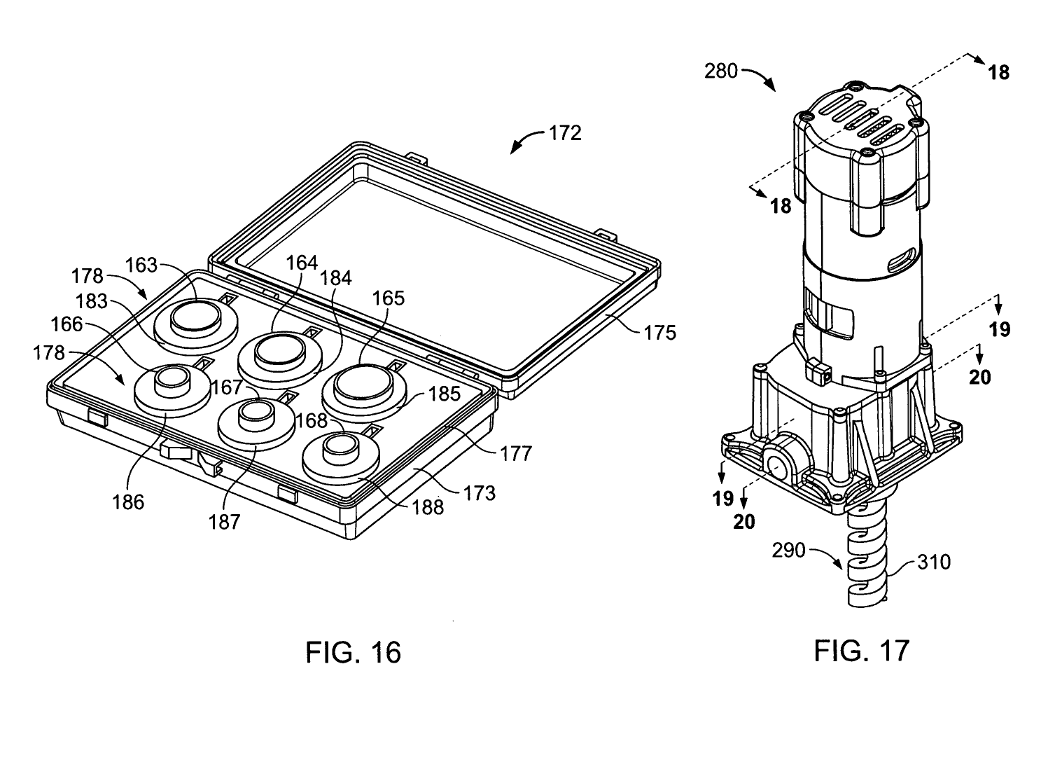

FIG. 16 is a three-dimensional view of a holder for the smallest diameter lubricators.

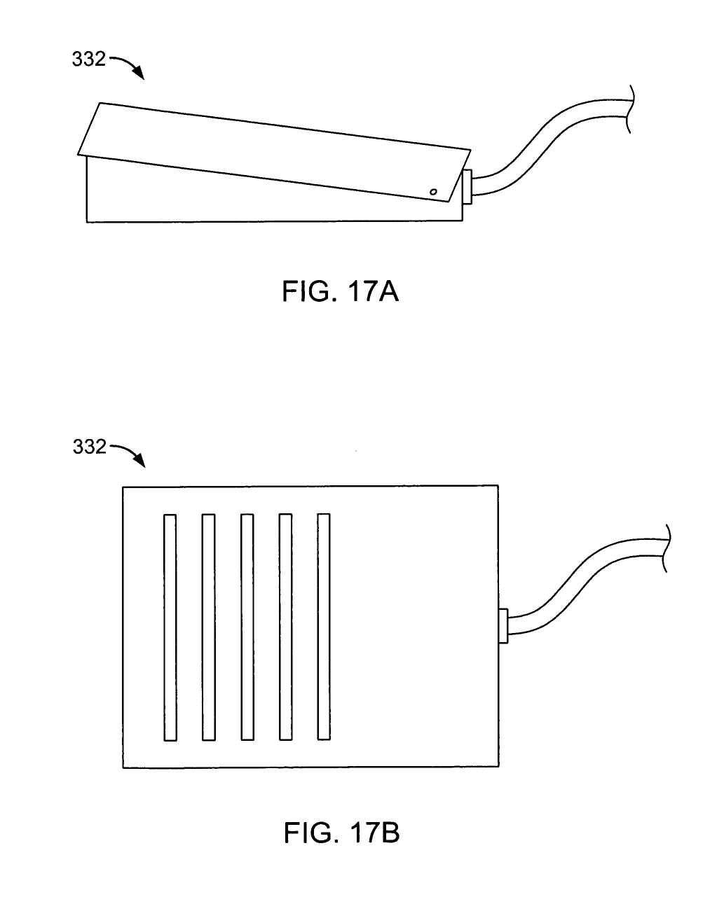

FIG. 17 is a three-dimensional view of a pump.

FIG. 17A is a side view of the foot switch.

FIG. 17B is a top view of the foot switch.

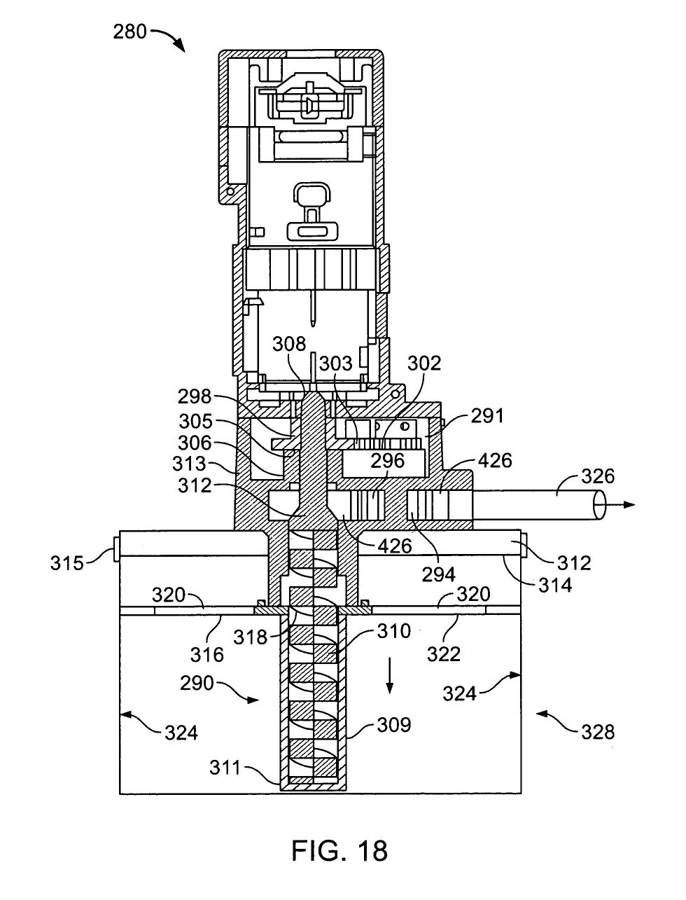

FIG. 18 is a side-sectional view of the pump along line 18-18 of FIG. 17.

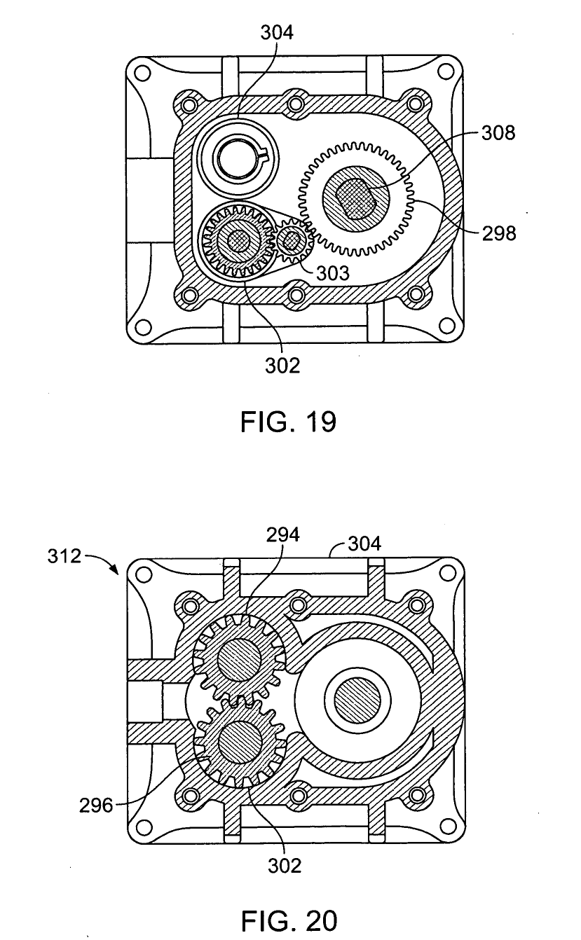

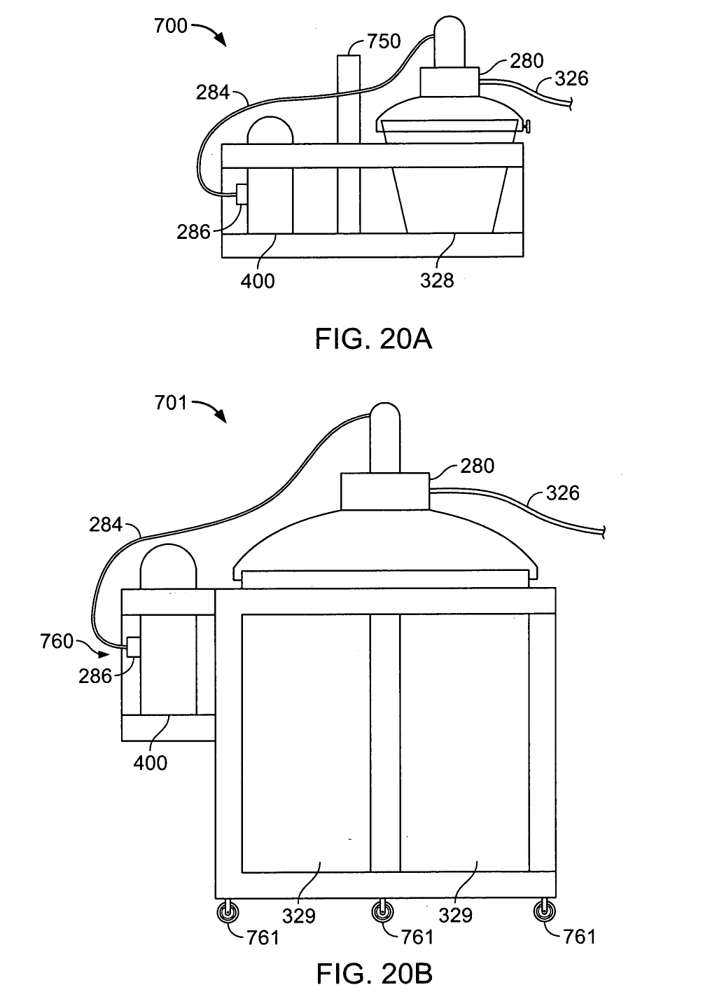

FIGS. 19 and 20 are cross-sectional views of the pump along lines 19-19 and 20-20 of FIG. 17.

FIGS. 20A and 20B are side views of the container.

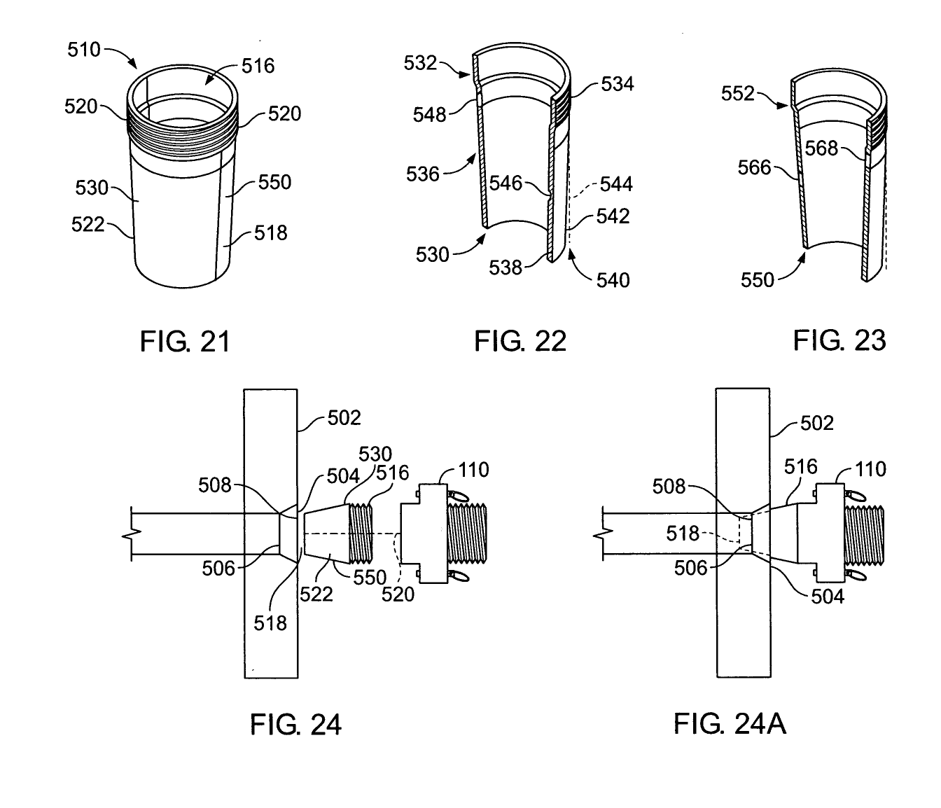

FIG. 21 is a three-dimensional view of an adaptor.

FIGS. 22 and 23 are three-dimensional views of the two pieces of the adaptor.

FIGS. 24 and 24A are schematic views of the adaptor in use.

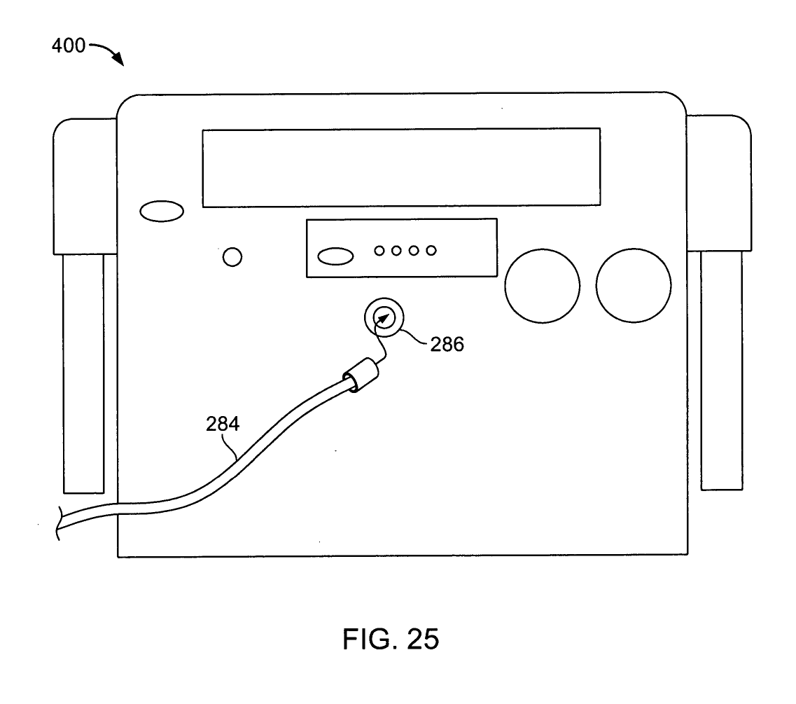

FIG. 25 is a side view of the battery and its electrical connector.

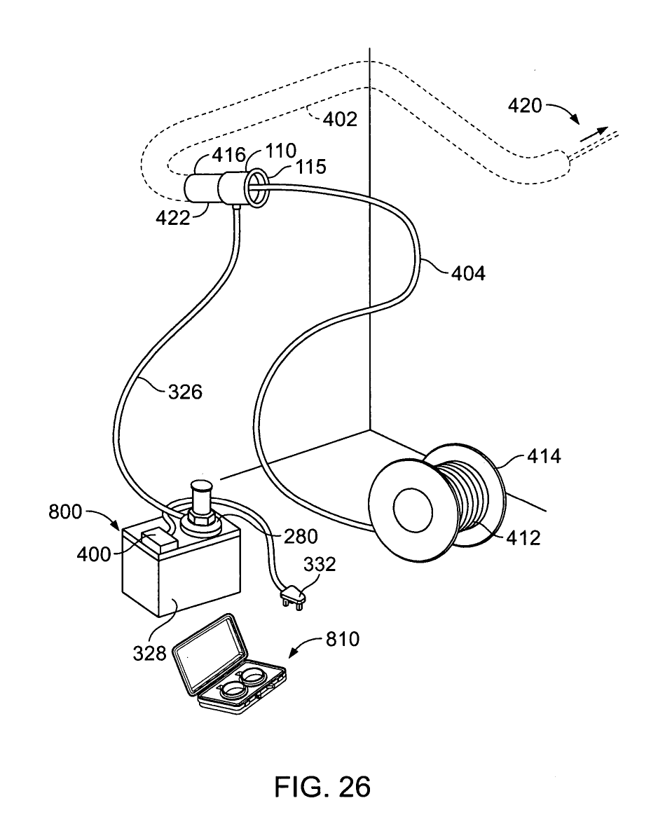

FIG. 26 is a three-dimensional view of a lubricator in use.

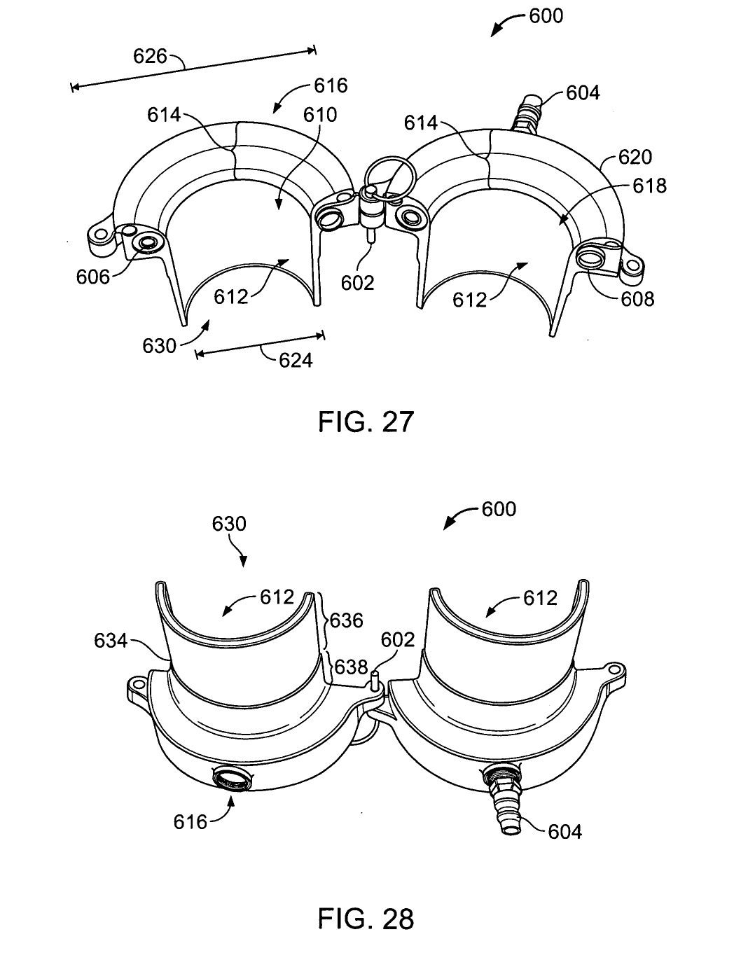

FIGS. 27 and 28 are perspective views of an example of a lubricator.

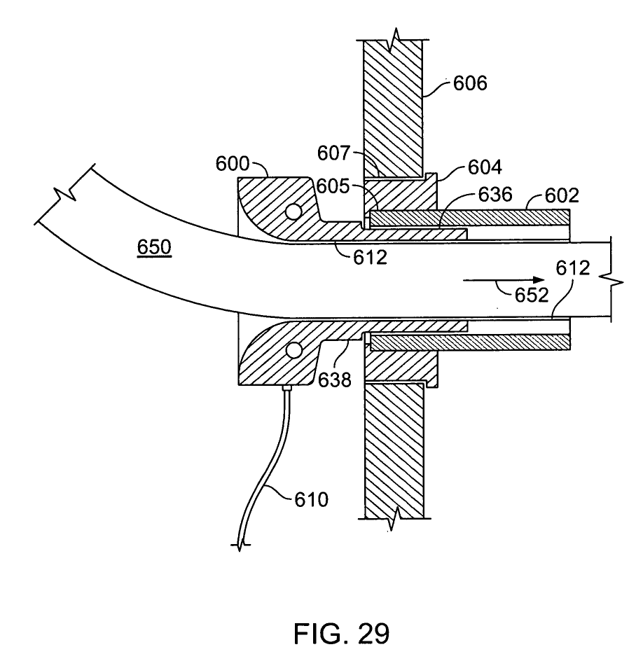

FIG. 29 is a schematic cross-sectional view of a lubricator in use.

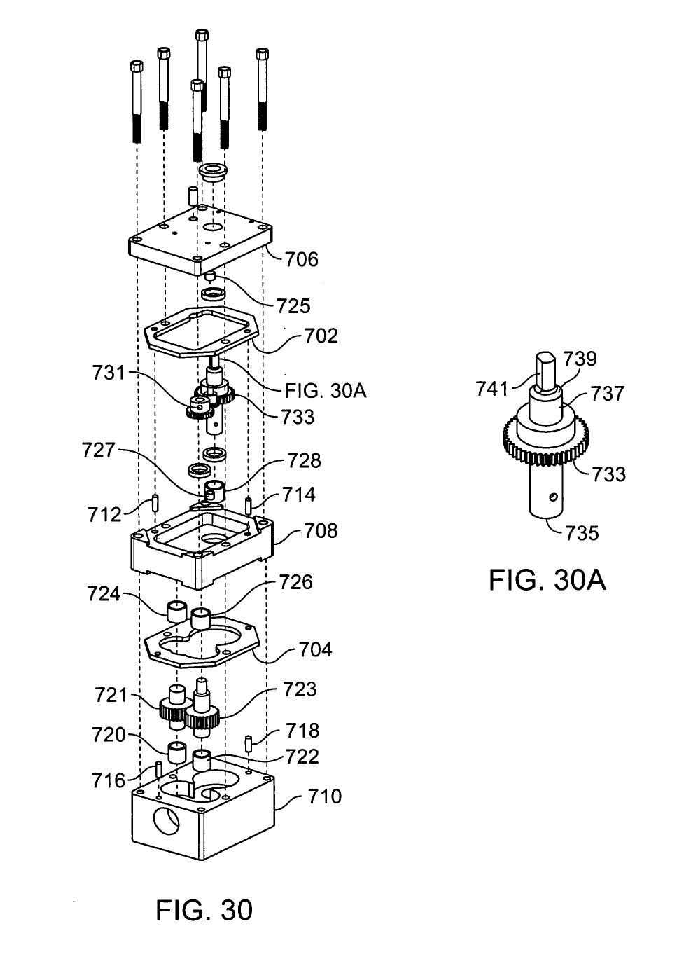

FIG. 30 is an assembly drawing of a pump.

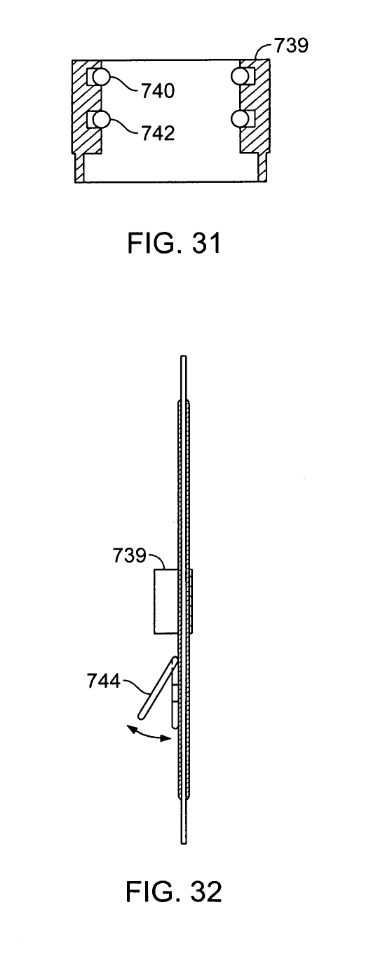

FIG. 31 is a sectional side view of a hub.

FIG. 32 is a side view of a follower plate.

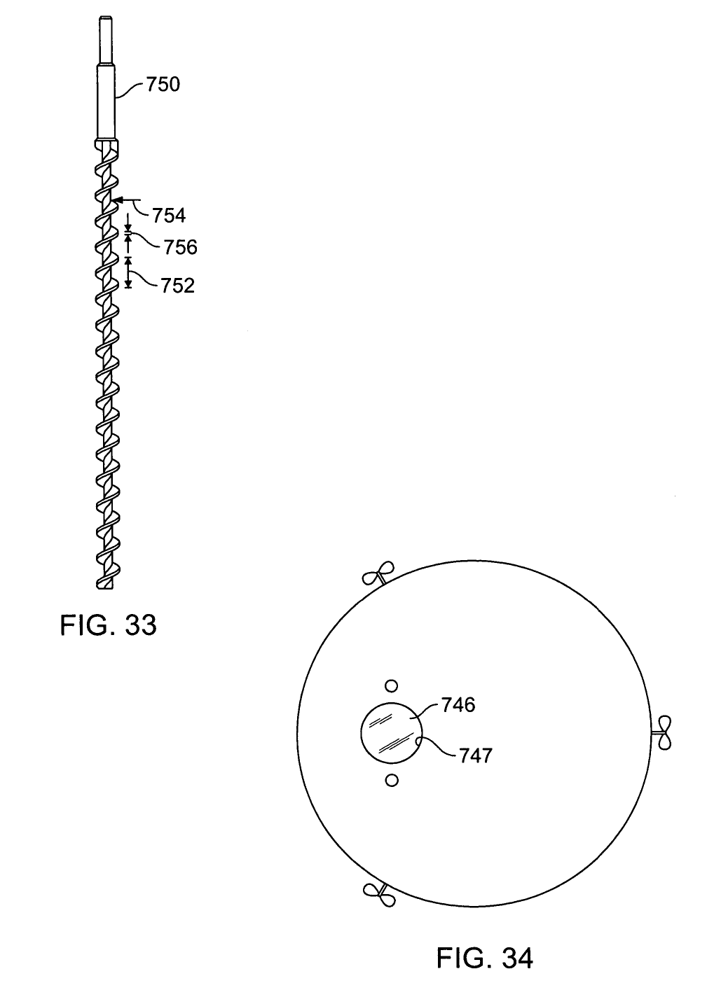

FIG. 33 is a side view of an auger.

FIG. 34 is a schematic top view of a flange.

Referring to the drawings and particularly to FIGS. 1 to 3, there is illustrated an automatic wire lubricating device, generally designated 10, in an assembled form. The device 10 basically includes first and second components 12, 14, each forming a body section 16, 18 of generally arcuate and more particularly of semi-cylindrical configuration, and detachable fastening means 20 at the opposite angularly displaced ends 16A, 16B and 18A, 18B of the respective body 10, sections 16, 18 for releasably securing the first and second components 12, 14 together at flat end faces 16C, 16D and 18C, 18D to provide the device 10 in the assembled condition of FIGS. 1 to 3. The flat end faces 16C, 16D of the body section 16 lie in a common plane and likewise the flat end faces 18C, 18D of the body section 18 lie in a common plane, as clearly seen in FIGS. 4 and 7.

Referring also to FIGS. 4 to 9, there is illustrated the first component 12 by itself in FIGS. 4 to 6 and the second component 14 by itself in FIGS. 7 to 9. The first component 12 of the device 10 has a quick-connect member 22 which fits, such as by being screwed, into a pipe fitting 24 (such as 1/4 inch in size) being attached, such as by being welded, onto an outer circumferential side 16C of the body section 16 of the first component 12. The quick-connect member 22 can easily and quickly be attached to a soap line (not shown) coming from a pump (also not shown).

Alternatively, the male quick connect nipple could be replaced by a high flow nipple. And the female quick connect fitting may be changed to a high flow fitting with a ⅜″ female thread.

The body sections 16, 18 of the respective first and second components 12, 14 together form an annular body 27 open at its axially displaced opposite ends 27A, 27B with each body section 16, 18 defining one half of a continuous cylindrical interior reservoir 26 in the annular body 27, as seen in FIGS. 1-3, when the first and second components 12, 14 are fastened together. The continuous interior reservoir 26 is in flow communication with the quick-connect member 22 and pipe fitting 24 on the first component 12. The body sections 16, 18 also have respective dispensing or applicator holes 28, 30 defined through the interior walls portions 16D, 18D thereof which provide flow communication between the interior reservoir 26 and a central opening 32 formed through the annular body 27 of the device 10 by the first and second components 12, 14 thereof when the latter are fastened together. The annular body 27 being of cylindrical configuration has a longitudinal central axis A, as seen in FIG. 2, extending through the central opening 32 and between the opposite ends 27A, 27B of the annular body 27.

The first and second components 12, 14 additionally have formed on their body sections 16, 18 at one of the axially displaced opposite ends 27A of the annular body 27 respective halves of an internally threaded cylindrical clamping flange 34 which is concentric about the longitudinal central axis A of the annular body 27. Also, the detachable fastening means 20 are disposed adjacent to the outer circumferential sides 16E, 18E and the flat end faces 16C, 16D and 18C, 18D at the respective angularly displaced ends 16A, 16B and 18A, 18B of the body sections 16, 18. The detachable fastening means 10 include pairs of sleeves 36, 38 and pins 40. The sleeves 36, 38 are hollow for receiving the respective pins 40. The sleeves 36 at the respective ends 16A, 16B of the body section 16 and the sleeves 38 at the respective ends 18A, 18B of the body section 18 are axially offset relative to one another, extend substantially equidistantly in opposite directions relative to the continuous interior reservoir 26 in the annular body 27, and partially project beyond the respective flat end faces 16C, 16D or 18C, 18D, as seen in FIGS. 1 and 4-9. When the first and second components 12, 14 are assembled together at the flat end faces 16C, 18C and 16D, 18D of the body sections 16, 18, the sleeves 36, 38 at corresponding ones of the ends 16A, 18A and 16B, 18B of the body sections 16, 18 are disposed in pairs and aligned axially with one another along opposite side axes B, C, which extend substantially in a parallel relationship to the longitudinal central axis A of the annular body 27 and lie substantially in a common plane formed by said flat end faces, as seen in FIGS. 1-3. The pins 40 are slidably inserted through the pairs of aligned hollow sleeves 36, 38 so as to hold the two body sections 16, 18 of the first and second components 12, 14 together. For taking the first and second components 12, 14 apart, the pins 40 can be slidably withdrawn from the pairs of aligned sleeves 36, 38 in the same reverse direction along the respective parallel side axes B, C of the aligned sleeves 36, 38.

Further, coupler pins 42, 44 of hollow construction and slightly arcuate shape are attached at the flat end faces 16C, 16D and 18C, 18D of the angularly displaced opposite ends 16A, 16B and 18A, 18B of the body 15 sections 16, 18 of the first and second components 12, 14 so as to project outwardly from the flat end faces 16C, 16D and 18C, 18D and provide communication between the opposite ends of the halves of the interior reservoir 26 defined by the body sections 16, 18. The hollow coupler pins 42, 44 have O-rings 45 disposed around them and the coupler pins 42, 44 fit together so as to make a tight seal between the halves of the interior reservoir 26 where the flat end faces 16C, 16D and 18C, 18D of the body sections are placed flush together when the first and second components 12, 14 are fastened together.

The device 10 is connected to and held in place on a threaded end of a conduit (not shown) by attaching the two halves of the internally threaded cylindrical clamping flange 34 about the threaded end of the conduit as explained above by inserting the pins 40 into the aligned sleeves 36, 38. When a pump feeds liquid soap through the quick connect member 22 into the interior reservoir 26, the liquid soap travels 360 degrees through the interior reservoir 26 around the device 10 and squirts out through the interior dispensing or applicator holes 28, 30 onto the wire being pulled through the central opening 32 of the device 10 into the threaded end of the conduit.

The first and second components 12, 14 additionally have formed on their body sections 16, 18 at the other of the axially displaced opposite ends 27B of the annular body 27 respective halves of an externally threaded cylindrical nipple 46 which is concentric about the longitudinal central axis A of the annular body 27. The nipple 46 allows the attachment of a member such as a bushing thereon to keep from scaring the wire or a rubber grommet for ensuring a “no mess” application of soap on the wire during a vertical pull thereof.

The actual physical size of the device 10 depends on the trade size of the conduit one is pulling wire through, resulting in a different size device for each trade size of conduit. Also, it should be understood that the device 10 can be manufactured by various suitable conventional methods using various suitable conventional materials and having various different configurations.

In summary, the automatic wire-lubricating device 10 is a double pin clamping device that clamps over all trade size conduits and has a small male adapter or quick-connect 22 that connects to either a manual or electrical pump for supplying liquid soap into the device 10 and has a plurality of interior holes 28, 30, such as four in number, from which liquid soap is dispensed evenly and completely over the wire so as to lubricate the wire as it is pulled through the central opening 32 of the device 10. The advantages of the device 10 are: (1) mess free application; (2) less cleanup; (3) less manpower required; (4) less expense; and (5) more consistent job of lubricating the wire being pulled.

As shown in FIG. 10, in another example of a lubricator 110, two ribbed, semi-cylindrical pieces 116 and 118 can be fastened together (and unfastened) by detachable pins 120, 121 to mount (and remove) the lubricator, made of a material such as plastic, onto an externally threaded end 123 of a conduit 125.

By conduit, we mean in the broadest sense any kind of pipe, tube, sleeve, or other elongated element that has been fabricated in any manner using any continuous or discontinuous material and that has a channel or lumen within which one or more strands extend. One specific example of a conduit is a metal pipe used to carry electrical wires in a building. By strand we mean, in the broadest sense, a wire, cable, thread, braid, fiber, or other elongated element that has been fabricated in any manner using any material and may extend within a conduit alone or together with multiple strands equal in length. We sometimes use strand to refer to more than one strand.

The lubricator bears an internal thread 112 and an external thread 114. The internal thread and the external thread may be of the same pitch and diameter (which is useful in connection with attachment of a bushing described later) or may be of different pitches and diameters. The threads are shown in the figure as being aligned on a common axis, but they could also be aligned on different axes that are either parallel to one another or at an angle to one another.

The internal thread 112 enables the mating of the lubricator 10 with the externally threaded end 123 of the conduit 125. The external thread 114 enables the attachment of a conventional (or special) internally-threaded 117 protective bushing 115 to the lubricator 110. The bushing has a leading edge 103 that is, for example, smooth and rounded to protect a strand against abrasion and damage when it is pulled through the bushing. A hose (not shown) that carries a lubricant pumped from a supply (not shown) attaches to a pipe-fitting, using a quick-connect coupling (not shown). The fitting and coupling can be of the kind shown and described in FIGS. 1, 2, and 3. Lubricant that is pumped from the supply into the lubricator exits through dispensing holes 128 (only one is shown in FIG. 10) that open on an interior surface of the lubricator 110.

FIG. 11 shows a cross-section of the lubricator at 11-11 of FIG. 10. When the semi-cylindrical pieces 116, 118 are closed together, they may be fastened together by pins 120, 121 placed through the sleeves 124, 125. Within each of the pieces 116 and 118 and at locations near the sleeves 124, 125 are, in this instance, rings of silicon packing 134, 135, lying at the bottom of the grooves 1350, 1360, which assure a tight seal of the mating ends of annular tubes 137, 139 to form an interior reservoir that carries lubricant from the pipe fitting to the dispensing holes 128 (FIG. 10).

As shown in FIGS. 12 and 13, the lubricator 110 includes a removable, annular brush 144 shown in detail in FIG. 14 that is used to prevent leakage of the lubricant from the lubricator as the strand is being lubricated. When the amount of the lubricant fed from the dispensing holes onto the strand is more than is needed to lubricate the strand, the excess is retained in the chamber that is between the brush bristles and the end of the conduit.

The brush includes two semi-circular half-brushes 139, 141, each having a metal semi-circular ring 146, 148 (FIG. 14) that is held within a corresponding semi-circular groove 136, 138 that is formed in the interior wall 150, 152 of each piece 116, 118 of the lubricator 110. The semi-circular grooves are offset from one another along the axis of the lubricator so that when the two pieces of the lubricator are closed to mount the lubricator on the conduit, the bristles of the two halves will not engage one another in a way that makes closing the two pieces more difficult.

The semi-circular rings of the brush are configured to slide within the grooves to permit the halves of the brush 146, 148 (FIG. 14) to be removed for replacement by sliding. The replacement half-brushes 146, 148 are then fit snuggly in place after having been slid onto the semi-circular grooves 150, 138. Smaller versions (for example, smaller than 1½ inches in diameter) of the lubricator do not require a brush because they do not tend to leak lubricant. Those smaller lubricators resemble that of FIGS. 12 and 13, except for the absence of a groove for attaching a brush. Retaining clips 710, 720 hold the brush in place when the lubricator is separated into halves.

As FIGS. 14 and 14A show, each of the half brushes is semi-circular. One end of each of the bristles 160 is held in a the semi-circular ferrule 146 (bristles are not shown with the ferrule 148), which has a configuration that fits the lubricator groove 136. The other end of each of the bristles projects toward the axis of the ring. There are enough bristles in the brush to assure that the lubricant has difficulty leaking through the brush.

Because conduits vary widely in diameter, it is useful to have a variety of sizes of lubricators available. The lubricators of different sizes can be provided in sets. A set could include all of a wide range of sizes of lubricators (for example, twelve different lubricators ranging in internal diameter from 1/2 inch to 6 inches) or the lubricators can be organized in smaller sets that relate to specific size-ranges of conduits, for example, a set for smaller diameter conduits and a set for larger diameter conduits. The lubricators of a set can be housed in a holder such as the holders 170, 171, 172 for each of the sets 174, 176, 178 of lubricators 161-168, 910-913, as shown in FIGS. 15, 15A, and 16. The holder provides a convenient way to transport and store the set and prevents lubricant on the lubricators from either drying out or leaking out of the holder.

Each of the holders 170, 171, 172 is a closable container that includes a body 173, a lid 175, and a seal 177 between the body and lid. The lubricators 161-168, 910-913 come in small 178 (lubricators with diameters of ½, ¾, 1, 1¼, 1½, and 2 inches), medium 176 (with diameters of 2½, 3, 3½, and 4 inches), and large 174 (with diameters of 5 and 6 inches) sets, with each set containing at least two lubricators. Each lubricator 161-168, 910-913 sits in a separate receptacle 181-188, 920-923. When the lid of a holder is closed on the body and latched, the seals make the holder 170, 171, 172 airtight.

Each set contains at most six lubricators. A set includes a holder with appropriately sized receptacles each configured for one of the lubricators within the set; all the lubricators within one set are of a different size than all the lubricators within another.

Similarly, the receptacle for each lubricator is contoured to match at least a part of the lubricator to keep the lubricator in its place.

All of the lubricators of a set (and of all sets) share a common size and type of pipe-fitting and quick-connect coupling to accommodate one size of hose that extends from the pump.

As shown in FIG. 17, a pump 280 transfers the lubricant from a supply to the lubricator through a connecting hose (not shown in FIG. 17, 326 in FIG. 18). Using an auger 290 rotating within an auger tube (not shown in FIG. 17, 309 in FIG. 18), the pump forces a viscous lubricant from a standard bucket (not shown in FIG. 17, 328 in FIG. 18) in which the supply is held to an internal reservoir (hidden in FIG. 17) of the pump where the lubricant is held. The lubricant could be a viscous or non-viscous material, for example, a soap, a detergent, an oil, or a grease. The assembly also contains two meshing gears that form a gear pump. The gear pump forces the lubricant from the reservoir 138 into a hose (not shown in FIG. 17; 326 in FIG. 18), which then carries the lubricant to the lubricator. The auger 290 and the meshing gears (hidden in FIG. 17) of the pump are driven by a commercially available motor (not shown; available from Black & Decker in Kansas City, Mo.). The pump operator turns the motor on or off using a foot switch (not shown in FIG. 17, 332 in FIGS. 17A, 17B, and 26; also available from Linemaster Corporation in Woodstock, Conn.). The speed of the motor is controlled by a three-speed transmission, which controls the amount of lubricant dispensed onto the strand. The motor is powered by a battery (not shown in FIG. 17, 400 in FIG. 25). Alternatively, a 110V motor could be used.

The battery may be a standard 12-Volt battery held in a commercially available portable emergency housing (for example, available from Team Products International in Parsippany, N.J.). An electrical connector 286 (FIGS. 20A, 20B and 25) may be added to the housing of the battery to permit quick, reliable, repeated connection or disconnection of a cable 284 (FIGS. 20A, 20B, and 25) between the battery 400 (FIG. 25) and the pump 280. To help align the plug end of cable 204 with the female receptacle 286, an alignment channel may be added to battery pack and/or the male plug.

As shown in FIG. 18, within the reservoir 291 of the pump 280, the upper end of the shaft of the auger is housed together with the meshing gears 294, 296 of the gear pump so that when the lubricant is drawn into the reservoir by the auger, the lubricant will be picked up by the meshing gears and pumped to the supply line 326. As shown in FIG. 19, above the reservoir, one of the meshing gears is driven by a drive gear 302, which in turn is driven by an intermediate gear 303, which in turn is driven by an auger gear 298 that is connected to the upper end of the auger shaft 306. The upper end of the auger shaft is keyed 308 to the auger gear. The keyed upper end of the auger shaft (at a location above the auger gear) is driven by the motor. The gear ratio effected by the auger gear, the intermediate gear, and the drive gear is arranged to tend to force an oversupply of lubricant into the reservoir 426 relative to the flow of the lubricant from the reservoir to the supply line.

The auger 290 has a screw portion 310 arranged along its length, and a tubular sleeve 309 around the screw that defines a channel from the tip of the auger 311 to the top of the auger 312. During operation, as the auger is driven by the motor, lubricant is drawn up from the supply bucket into the reservoir 426. The meshing gears 294, 296 force the lubricant out of the reservoir 426 and into the connecting hose 326, to be dispensed by the lubricator (for example, the lubricator shown in FIG. 10) onto a strand. The outlet hole from the reservoir to the connecting hose should be large enough, e.g., ¾″ to reduce back pressure on the pump. The fittings connected to the outlet hole may include a ¾″ cross on one side of which is a ¾″×¼″ brass reducing bushing and the pressure gauge. The other side of the cross bears a bleed valve. The connecting hose has a ⅝″ ID with a ¾″ male thread on one end and a ¼″ or ⅜″ male thread on the other end.

The block 312 that contains the reservoir is bolted to a flange 314 that serves as a substitute lid for the supply bucket. The flange 314 is round and has a peripheral wall 315 that is sized and configured to mate with the opening of the bucket and supports the pump 280 that sits atop it. Inside the bucket, a follower plate 316, with a hole 318 slightly larger in diameter than the diameter of the auger tube can slide freely down the auger tube as the lubricant is pumped out. The follower plate 316 has a steel center disk 320 and a flexible outer ring 322 that wipes the inner wall 324 of the bucket as the follower plate descends. As the lubricant is pumped out of the bucket, the follower plate descends by gravity, wiping the inner wall clean and causing the remaining supply of lubricant to lie in a compact cylindrical mass on the bottom of the bucket. This arrangement assures that the auger can pump effectively until all of the lubricant is removed.

As shown in FIG. 31, the follower plate may have a center hub 739 that includes two O-rings 740, 742 on the top and bottom of the center hub. The follower plate is supported on and guided along the feed tube so that, as lubricant is depleted, the plate continues to ride on the surface of the lubricant supply. The o-rings serve as a barrier so that lubricant does not leak into the space above the plate. Using two o-rings reduces the chances, present when only one o-ring is present, that the follower plate will twist to one side preventing it from sliding down the suction tube as intended. The two o-rings keep the plate level.

In addition, a handle 744 may be included to the top of the follower plate, as shown in FIG. 32, to make it easier to remove. The follower plate is formed of stainless steel.

As shown in FIG. 34, the flange (lid) may be provided with a Plexiglas window 746 mounted at a 1½″ hole 747 in the flange to enable the user to view the level of the follower plate within the lubricant vessel without having to lift the bucket lid.

The auger should be designed so that it delivers lubricant to the pump at a rate that is matched to the rate at which the pump delivers the lubricant to the lubricator. For example, if the gear pump delivers lubricant faster than the auger feeds lubricant to the pump, the gear pump is starved, which increases the frequency with which the pump must be bled and increases the load on the motor. The choice of pitch, minor diameter, and outside diameter of the auger affect the rate at which the auger delivers lubricant to the pump. As shown in FIG. 33, in one useful example, the auger 750 has a screw pitch 752 of 1.00″, a minor diameter 754 of 0.250″, and a face width 756 of 0.125″. The outside diameter 757 of the auger is 0.688″ and the maximum pressure achieved by this arrangement at the outlet end of the pump is 250 psi.

The surfaces between the layers of the pump housing may be double machined to reduce leakage of the pressurized lubricant. Alternatively, as shown in FIG. 30, gaskets 702, 704 may be included between the top and middle layers 706, 708 and between the middle and bottom layers 708, 710 of the pump housing to reduce the chance of leakage. The layers of the pump housing are, in that case, machined to accommodate the gaskets.

Locator pins 712, 714, 716, 718 may be added between the pump body layers, two between the top and middle layers, two between the middle and bottom layers. The locator pins ensure correct alignment during the assembly process. Without the locator pins, it may be possible to twist the gears slightly causing the pump to perform poorly.

Cylindrical brass bushings may also be added on the gear shafts of the pump to make the pump last longer and work better. As shown in the FIG. 30, two of the bushings 725, 727 serve the top and bottom of the drive idler gear 731. Four of the bushings 720, 722, 724, 726 serve the top and bottom of the two pump drive gears 721, 723. One of the bushings 728 serves the bottom of the drive gear 731.

To spread the load across the transition, the drive gear 731 may bear a radius cut 739 in the top of the gear shaft 735 where it transitions from the shaft 741 that goes into the motor to the larger diameter portion of the shaft 737.

The steel gears 721, 723, 733 may be plated with a 0.002″ thick coating of electro-less nickel to reduce corrosion caused by water based lubricants and air that may leak into the pump body. Alternatively, the gears may be made of stainless steel, type 304, for example.

The gear ratio of the drive gears should be chosen to provide good performance, reduced load on the motor, and increased battery life. One example would be a gear ratio of 1 to 1.6. However, it is believed that a gear ratio of 1 to 0.8 or 1 to 0.6 ratio will provide better performance. The auger may be made of steel or a polymeric material.

FIGS. 20A and 20B show side views of two containers 700, 701 that hold the battery 400, pump 280, and either a one-gallon (FIG. 20A) or a five-gallon (FIG. 20B) supply bucket 328, 329. The battery 400 is connected to the pump 280 by a cable 284 attached to an electrical connector 286. The pump 280, in turn, is connected to the lubricator (not shown) by a hose 326. For the one-gallon supply bucket 328 in FIG. 20A, both the pump 280 and supply bucket 328 sit within the same container 700 as the battery 400. A handle 750 allows for the container 700 to be carried by hand. For the five-gallon supply bucket 329 in FIG. 20B, the battery 400 sits in a separate compartment 760 from the pump 280 and supply bucket 329. This container 701 is transported on casters 761. Both are metal containers 700, 701 that prevent leakage of lubricant when the assembly is transported.

In some situations, the near end of the conduit lacks threading, such as when the conduit is held in a wall 502 of a manhole 504 with the end 506 of the conduit held near the inside of wall 508, as illustrated in FIGS. 24 and 24A. In such a situation, an adaptor 516 may be mounted on the near end of the conduit to provide a threaded end onto which the lubricator 110 may be screwed. The adaptor 516 has two semi-cylindrical halves 530, 550 that, when mated, form an annular body 516. The smooth end 518 of the adaptor slides into the conduit while the threaded end 520 receives the lubricator 110. The outer wall 522 of the adaptor is tapered so that the adaptor slides easily into conduits of slightly different inner wall diameters and can be jammed into the conduit to hold it securely during the pulling operation. Once lubrication is completed, the lubricator 110 is removed from the adaptor 510 by detaching the semi-cylindrical halves of the coupling 530, 550; similarly, the adaptor 510 slides out from the conduit 580 and the adaptor's semi-cylindrical halves 530, 550 are subsequently separated from each other.

As shown in FIG. 22, a piece 530 that forms half of the manhole adapter has a semi-cylindrical upper section 532, which includes external threads 534 that are sized to accept the internal threads of one end of a lubricator (for example, the lubricator shown in FIG. 10), and a semi-cylindrical lower section 536, which includes a tapered wall 538. The diameter of the lower section 536 enables it to fit with a conduit (not shown) that is mounted within a wall of a manhole. The taper is represented by an offset 540 of the outer surface of section 540 relative to an imaginary line 544 that is a line with the central axis (not indicated) of the adaptor. Two notches 546, 548 in the edges of piece 530 are configured to mate with two plugs 566, 568 of the other half of the adaptor (shown in FIG. 23) to form the complete adaptor (shown in FIG. 21) and to prevent relative motion of the receptive two halves of the adaptor along the central axis.

Likewise, as shown in FIG. 23, a piece 550 that forms the other half of the manhole adaptor also has a semi-cylindrical upper section 552 and has essentially the same configuration as the piece 530 shown in FIG. 22, except that it has two plugs 566, 568 configured to mate with two notches 546, 548 of the other half of the adaptor (shown in FIG. 22) to form the complete adaptor (shown in FIG. 21) and to prevent relative motion of the receptive two halves of the adaptor along the central axis.

FIG. 25 shows a standard 12-Volt emergency battery 400 with its electrical connector 286 and an electrical connecting cable 284; in this illustration, the battery is not attached to the pump's motor.

As shown in FIG. 26, in use, the battery 400 is electrically connected by the cable to the motor within the pump 280. A lubricator 110 is attached to a conduit 402, through which a strand 404 is being pulled. A hose 326 connects the lubricator 110 to the pump 280 that sits atop a standard supply bucket 328 filled with lubricant. A foot switch 332 controls the connection of the battery 400 to the motor, while a three-speed transmission controls the motor's speed to regulate the rate at which lubricant is pumped onto the strand 404.

As shown in FIG. 26, in use, the electrician brings to the job site the container 800 that holds the bucket of lubricant and the pump and also brings the holder 810 that contains the lubricator to be used on the job. Assume that an insulated wire 404 from a supply 412 is to be pulled from a supply spool 414 at a near end 416 of the conduit through a steel conduit 418 to the other end 420. The electrician takes the lubricator that is of the correct size for the conduit from the holder and mounts it on the end of the conduit either by screwing it onto the external threads or by removing one of the pins, opening the lubricator and then closing it over the end of the conduit and replacing the pin. If a standard bushing 422 has not previously been mounted on the other end of the lubricator, the electrician screws it onto the threads.

From the other end of the conduit a stiff wire is forced through the conduit to the near end. A free end of the wire to be pulled is then attached to the free end of the stiff wire. If not already done, the electrician attaches the foot switch to the motor of the pump and places it in a convenient location. If not already done, he mounts the pump on the top of the bucket of lubricant. He connects one end of a supply line to the outlet of the pump and the other end of the supply line to the quick-release coupling of the pump. He connects the battery connector to the pump using an electrical cable.

The stiff wire at the far end of the conduit is pulled to begin to pull the insulated wire into the near end of the conduit. The electrician steps on the foot switch to begin to force lubricant into the supply, into the reservoir in the lubricator, and from the reservoir into the chamber that lies between the brushes and the near end of the conduit. With the lubricant flowing, the electrician draws a supply of the insulated wire from the spool as the stiff wire is pulled from the far end of the conduit. As the insulated wire passes through the conduit, the outer wall of the wire is automatically coated with lubricant from the supply that is built up in the chamber next to the brushes. The electrician at the same time can both feed wire from the spool and control the speed of lubricant pumping using the foot switch to control the motor speed. If the rate of pumping is too high, lubricant may begin to be forced through the brush. The electrician could then reduce the motor speed. If the rate of pumping is too low, the wire will not feed easily through the conduit, and the electrician can increase the rate of pumping.

The gear pump is capable of very high pumping pressures (e.g., as high as 2500 psi). In combination with the auger approach of drawing lubricant from the bucket, this makes it possible to successfully pump extremely viscous lubricants from the bucket and feed them into the lubricator.

When the end of the insulated wire has been pulled through the conduit and extends as far as needed from the far end of the conduit, the electrician can stop the pump. The next step is to unscrew the bushing from the end of the lubricator. Then the lubricator is removed from the end of the conduit by removing one of the pins and opening the two halves. Once the lubricator has been removed, the bushing, which has the insulated wire running through it and has been held near the end of the conduit, is screwed onto the end of the conduit to complete the wire-pulling job.

The lubricator can then be returned to the holder without cleaning it, and the pump with bucket and the battery can be returned to the carrier also without cleaning them.

With use, the half-brushes may become worn or damaged and need to be replaced. Replacement is done simply by sliding the metal ring ferrule along the groove in which it is held until it is free and then reversing that step using the replacement brush.

Referring to FIGS. 27 and 28, other examples of lubricators 600 may be configured for use in environments in which the cable can be pulled through the lubricator and the conduit, while the lubricator is held in an orientation in which excess lubricant will drain into the conduit rather than spill from the open end of the lubricator. In such environments, it is not necessary to provide a brush or other device to retain the lubricant within the lubricator as would be useful in applications in which the entry end of the lubricator may face downward.

In both FIGS. 27 and 28, the lubricators are shown with their two halves open. In use, the two halves are fitted around the cable, closed, and held together by two pins 602 (only one shown) in the same way as described earlier. The lubricator 600 likewise has an annular lubrication reservoir that lies within the wall of the lubricator in two sections 606, 608 that are joined when the lubricator is closed. A fitting 604 carries lubricant from a supply into the reservoir. And four holes 610 dispense the lubricant from the reservoir into the space enclosed by the inside wall of the lubricator.

The lubricator is cast of aluminum and the inside wall 612 of the lubricator is smooth and cylindrical. The space enclosed by the inside wall when the lubricator is closed is unobstructed to allow free passage of the cable. The inside wall flares out in a bell-shaped surface 614 at an entry end 616 of the lubricator (the end that receives the cable first). The bell-shaped surface has a narrower circular end 618 that matches the cylinder of the annular surface 620 of the inner wall and a broader circular end 622 at the entry end of the lubricator. The bell-shaped surface forms a quarter of a toroid.

The broad end of the bell-shaped surface is at least half again as wide 626 (in some cases about twice as wide) as the space 624 surrounded by the annular surface. The bell-shaped surface and the annular surface are coaxially aligned.

At the exit end 630 of the lubricator, the outer wall 634 is cylindrical and is unthreaded. The outer wall includes one section 636 of smaller diameter and another section 638 of larger diameter. The smaller diameter section corresponds to the inner diameter of one grade of conduit that has a particular outer diameter. The larger diameter section 636 corresponds to the inner diameter of a second grade of conduit that has the same outer diameter as the first grade of conduit. Because the two grades of conduit have the same outer diameter, they can both use the same connector sleeves for the purpose of coupling the conduit to, say, a wall of a manhole. Thus, a given lubricator can be slipped inside and held tightly within two different grades of conduit that have the same outside diameter.

The smaller diameter section extends at least 40% of the distance to the entry end of the lubricator. When the lubricator is mounted on the smaller inside diameter conduit, the smaller diameter section of the lubricator is long enough to provide stable support. When mounted in the larger inside diameter conduit, the smaller diameter section 636 can provide some support to assist the larger diameter section of the lubricator; as a result a relatively shorter larger diameter section 638 is sufficient for stable mounting.

As shown in FIG. 29, in one application, a conduit 602 having a connector 604 mounted on one end 605 is held by the connector within a hole 607 of a wall 606 of a manhole. A cable 650 is to be pulled 652 from another end of the conduit (not shown) through the conduit from the end 605.

The lubricator 600 may be inserted into the end 605 of the conduit before the cable is first pulled into the conduit, or may be installed around the cable after the cable has been first fed into the conduit, or the operations can be performed at the same time. A hose 610 feeds lubricant from a supply (not shown) to the lubricating mechanism of the lubricator. Lubricant 612 is then continuously fed onto the outer surface of the cable. The lubricant is drawn into the conduit on the outer surface of the cable and eases the pulling effort.

Because the lubricator is oriented with the center of the entry end no lower than the center of the exit end, the lubricant does not leak or drip from the entry end. The lubricator could also be used for a “down pull” and for pulling at other angles, without the lubricant leaking.

In some implementations the transition 640 between the smaller diameter section 636 and the larger diameter section 638 is abrupt. In other implementations there could be a gradual taper of the outer wall, the taper including sections of each of the larger diameter and the smaller diameter.

Although particular implementations have been described above, other implementations are also within the scope of the following claims.

For example, the lubricator can be mounted on the conduit and the bushing can be mounted on the lubricator using mechanisms other than threads.

1. A device to dispense lubricant onto a cable as the cable enters a conduit through which the cable is being pulled, the device comprising
an inside wall that flares out in a bell-shaped surface to an entry end of the device where the cable enters, the space enclosed by the inside wall being unobstructed, and
a lubricant dispensing structure to dispense the lubricant automatically at the inside wall and onto the length of cable as the cable is being pulled.

2. The device of claim 1 in which
the inside wall includes an annular surface, and
the bell-shaped surface has a narrower end that joins the annular surface and a broader end at the entry end of the device.

3. The device of claim 2 in which the bell-shaped surface has a circular cross-section and the annular surface has a circular cross-section.

4. The device of claim 2 in which the region surrounded by the broader end of the bell-shaped surface is at least half again wider than the space surrounded by the annular surface of the inside wall.

5. The device of claim 4 in which the region surrounded by the broader end is approximately twice as wide as the space surrounded by the annular surface.

6. The device of claim 1 in which the bell-shaped surface and the annular surface are coaxially aligned.

7. The device of claim 1 in which the bell-shaped surface comprises a quarter-toroid.

8. The device of claim 1 in which the lubricant dispensing structure includes lubricant apertures that open on the inside wall.

9. The device of claim 1 in which the inside wall is formed by two portions that can be split apart and rejoined to position the inside wall around the cable in preparation for dispensing lubricant.

10. The device of claim 9 in which the lubricant dispensing structure is also formed in two portions that can be split apart and rejoined to form an annular lubricant chamber.

11. The device of claim 1 also including
an unthreaded outer cylindrical wall at the exit end of the device, the outer wall having a section of smaller diameter at the exit end and a section of larger diameter spaced apart from the exit end, the smaller diameter and the larger diameter sections corresponding to two different inner diameters of two different conduits, the two different conduits sharing a common outer diameter.

12. A device to dispense lubricant onto a cable as the cable enters a conduit through which the cable is being pulled, the device comprising
an inside wall that includes an annular surface and flares out in a bell-shaped surface to an entry end of the device where the cable enters, the space enclosed by the inside wall being unobstructed, the bell-shaped surface having a narrower end that joins the annular surface and a broader end at the entry end of the device, the bell-shaped surface and the annular surface having circular cross-sections and being coaxially aligned, the bell-shaped surface being a quarter-toroid, the region enclosed by the broader end of the bell-shaped surface being approximately twice as wide as the space surrounded by the annular surface of the inside wall,
a lubricant dispensing structure including apertures that open on the inside wall to dispense the lubricant automatically at the inside wall and onto the length of cable as the cable is being pulled, the inside wall being formed by two portions that can be split apart and rejoined to position the inside wall around the cable in preparation for dispensing lubricant, the lubricant dispensing structure also being formed in two portions that can be split apart and rejoined to form an annular lubricant chamber, and
an unthreaded outer cylindrical wall at the exit end of the device, the outer wall having a section of smaller diameter at the exit end and a section of larger diameter spaced apart from the exit end, the smaller diameter and the larger diameter sections corresponding to two different inner diameters of two different conduits, the two different conduits sharing a common outer diameter.

13. A device to dispense lubricant onto a cable as the cable enters a conduit through which the cable is being pulled, the device comprising
an inside wall defining an inside space through which the cable passes from an entry end of the device to an exit end of the device as the cable is being pulled through the conduit,
a lubricant dispensing structure to dispense the lubricant automatically at the inside wall and onto the length of cable while the cable is being pulled, and
an unthreaded outer cylindrical wall at the exit end of the device, the outer wall having a section of smaller diameter at the exit end and a section of larger diameter spaced apart from the exit end, the smaller diameter and the larger diameter sections corresponding to two different inner diameters of two different conduits, the two different conduits sharing a common outer diameter.

14. The device of claim 13 in which a transition between the smaller diameter section and larger diameter section is abrupt.

15. The device of claim 13 in which the section of smaller diameter extends from the exit end at least 40% of the distance to the entry end of the device.

16. The device of claim 13 in which the length of the smaller diameter section is at least twice the length of the larger diameter section.

17. The device of claim 13 in which
the inside wall includes an annular surface and a bell-shaped surface has a narrower end that joins the annular surface and a broader end at the entry end of the device.

18. The device of claim 17 in which the bell-shaped surface has a circular cross-section and the annular surface has a circular cross-section.

19. The device of claim 17 in which the broader end of the bell-shaped surface is at least half again wider than the space surrounded by the annular surface of the inside wall.

20. The device of claim 19 in which the region surrounded by the broader end is approximately twice as wide as the space surrounded by the annular surface.

21. The device of claim 13 in which the lubricant dispensing structure includes lubricant apertures that open on the inside wall.

22. The device of claim 13 in which the inside wall is formed by two portions that can be split apart and rejoined to position the inside wall around the cable in preparation for dispensing lubricant.

23. An apparatus comprising
a vessel to hold a supply of lubricant to be pumped to a lubricator for application to a cable that is being pulled,
a generally vertical guiding column, and
a follower plate to ride on an upper surface of the lubricant as the supply of lubricant in the vessel is depleted,
the follower plate having a pair of resilient barriers that support the plate on the guiding column, constrain the lubricant within the vessel below the plate, and are spaced apart along the length of the guiding column.

24. The apparatus of claim 23 in which the barriers comprise o-rings.

25. The apparatus of claim 23 in which the guiding column comprises a tube through which the lubricant is pumped.

26. An apparatus comprising
a gear pump to pump lubricant to a lubricator for application to a cable that is being pulled, the gear pump having an inlet and an outlet, and
an auger to feeds lubricant from a supply in a vessel to the inlet of the pump,
the gear pump comprising a pair of meshing gears that force lubricant from a reservoir at a rate based on a gear ratio of the gears,
the auger comprising a rotary screw that feeds lubricant at a rate based on a pitch and diameter of the screw,
the pitch and diameter of the screw and the gear ratio of the gears being selected so that the rate at which the auger feeds lubricant is matched to the rate at which the gear pump pumps lubricant.
